(19) United States
(12) Patent Application Publication
(10) Pub. No.: US 2008/0164823 A1
(43) Pub. Date: Jul. 10, 2008

(54) METHOD AND LIGHT EMITTING DIODE BACKLIGHT SYSTEM WITH ADJUSTABLE COLOR GAMUT

(75) Inventors: Danding HUANG, Kowloon (HK); Shou Lung Chen, Shatin (HK); Huajun Peng, Tai Po (HK); Ying Liu, Hung Hum (HK); Chen-Jung Tsai, Shatin (HK)

Correspondence Address: MERCHANT & GOULD PC, P.O. BOX 2903, MINNEAPOLIS, MN, 55402-0903, US

(73) Assignee: Hong Kong Applied Science and Technology Research Institute Co. Ltd., Shatin (HK)

(21) Appl. No.: 11/970,865

(22) Filed: Jan. 8, 2008

(30) Foreign Application Priority Data
Jan. 8, 2007 (CN) 200710000920.3

(51) Int. Cl. H05B 37/02; H05B 41/36

(52) U.S. Cl. 315/150; 315/309

(57) ABSTRACT

The present invention provides a lighting structure having a light source, wherein the light source configures at least one WLEDs and at least one multicolored LED units to obtain a layout of the lighting structure, wherein the at least one multicolored LED units comprise combinations of red light, green light and blue light LEDs or any multicolored LED combinations that are able to mix up white light; and a driving control system for automatically providing a plurality of driving signals of the light source according to a preset first setting value or providing a plurality of driving signals of the light source according to a second setting value of user input. And according to system preset or user input, provide light source with high color gamut and low power consumption. The light source can be used in liquid crystal display devices.

### FIELD OF INVENTION

The present invention generally relates to field of backlight systems, and more particularly relates to using different electrical driving values to drive light emitting diode (LED) and adjusting color gamut of LED backlight systems with adjustable color gamut and method.

### BACKGROUND

Color gamut is a range of red, green and blue that can be correctly rendered on a display, and is commonly expressed as a percentage of NTSC. Therefore, 100% of NTSC refers to the full range of color that can theoretically be displayed. In liquid crystal display, the conventional displays with Cold Cathode Fluorescent Lamp (CCFL) generating light source exhibit approximately 70% NTSC. In another method of generating light source a light emitting diode (LED) is used. The LED is a single-colored semiconductor light source that can generate various colors. When requiring a white light source, the single-colored LED currently generates white light by two kinds of methods. One method is by using combination of LED emitting red light, green light and blue light to generate white light, and the other method is by introducing fluorescent material into ultra-violet light, blue light or green light LED, so that initial lights emitted from the semiconductor tube of the LED is converted to light with longer wavelength, then the light with longer wavelength and the ultra-violet light, blue light or green light of the initial light combine to form white light. Such method is called phosphor-converted white light LED (WLED). In the first method, red light, green light and blue light LEDs is usually above 100% NTSC due to its pure color saturation.

In comparison to the first method of generating white light with combination type LED, phosphor-converted white light LED requires only one single-colored LED to generate white light with high efficiency, high luminance characteristics. When incorporating in backlight systems, it can achieve low power consumption. However, the color gamut is poor, which means the white light generated by phosphor-converted white light LED can less correctly display other colors after processing.

LIM, KEVIN L. L. et al. disclosed “System and method for producing white light using LEDs” in U.S. Pat. No. 7,009,343, wherein the abstract describes: a system and method for producing white light, the system and method comprise using combinations of white light, red light, green light and blue light LEDs to generate white light and responding feedback signals to adjust emitted light. LIM, KEVIN L. L. et al. use a color sensor for sensing color to generate a feedback signal, and adjusting the LED combination with the signal. This method can automatically control color gamut of white light to be at a desired value, but it does not achieve power saving. On the other hand, as a mater of fact using feedback system to generate feedback signal for controlling in some conditions is unnecessary and it does not allow the user to select desirable operation mode.

Given the above defects, the present invention provides a display device providing a combination of low power and high color gamut percentage with optimal image reproducing ability. The present invention has advantages of providing light sources with high color gamut or low power consumption according to system preset or user input. According to the above advantages, the present invention further provides advantages of more flexibly operating liquid crystal display device by adjustable color gamut and realizing large-size side-emitting backlight, with power-saving character and good displaying performance.

### SUMMARY OF INVENTION

The present invention provides a lighting system, which can be manually or automatically controlled according to user requirements or surrounding environment, which characterized in providing high color gamut and low power-consumed light source according to usage. The lighting system mixes at least one WLEDs and at least one multicolored LED units for generating white light and driving control system that can simultaneously control all LEDs. In the situation of having the display system as standard luminance (for example, liquid crystal display requires brightness to be 250 nits), when low power-conusmed environment is required, it only needs to increase electrical driving value of WLED or decrease electrical driving value of multicolored LED. In addition, in the environment requiring high color gamut display, it is to increase electrical driving value of multicolored LED or decrease electrical driving value of WLED to achieve user requirements with different conditions, wherein electrical driving value comprises voltage and/or current.

Therefore the present invention provides a lighting system generating backlight, comprising a lighting structure having a light source, wherein the light source configuring at least one white light emitting diode (WLED) and at least one multicolored light emitting diode (LED) unit to obtain a layout of the lighting structure; and a driving control system for providing driving signals and by individually adjusting a light radiation flux of the at least one WLED and a light radiation flux of the at least one multicolored LED units to adjust color gamut of the lighting structure, wherein adjusting the light radiation flux is by adjusting the electrical driving value provided by the driving control system to the at least one multicolored LED unit or the WLED. Wherein the at least one multicolored LED units comprise combinations of red light, green light and blue light LEDs or any multicolored LED combinations that are able to mix up white light. Wherein adjusting the color gamut of the lighting structure is by increasing the light radiation flux of the at least one multicolored LED units or decreasing the light radiation flux of the at least one WLEDs to increase color gamut. On the other hand, adjusting the color gamut of the lighting structure is by increasing the light radiation flux of the at least one WLEDs or decreasing the light radiation flux of the at least one multicolored LED units to decrease power. Wherein the driving control system can be automatic controlled by a preset program or manually controlled by user, or by through a feedback system or a light sensing device to generate control parameter for automatic control, wherein presetting comprises input setting a first setting value of NTSC value and setting a first standard value of emitted light luminance; and user manual control comprises input setting a second setting value of NTSC value and setting a second standard value of emitted light luminance. And the lighting system further comprises a memory system for memorizing the control parameter; and a data processing system for automatically control the driving control system according to the control parameter.

In addition, the present invention provides an operating method of backlight system, the method comprising providing a driving signal to a light source for generating white light, wherein the light source configuring at least one white light emitting diode (WLED) and at least one multicolored light emitting diode (LED) unit to obtain a layout of the lighting structure; and a driving control system for providing driving signals and by individually adjusting a light radiation flux of the at least one WLED and a light radiation flux of the at least one multicolored LED units to adjust color gamut of the lighting structure, wherein adjusting the light radiation flux is by adjusting the electrical driving value provided by the driving control system to the at least one multicolored LED unit or the WLED. Wherein the at least one multicolored LED units comprise combinations of red light, green light and blue light LEDs or any multicolored LED combinations that are able to mix up white light. Wherein adjusting the color gamut of the lighting structure is by increasing the light radiation flux of the at least one multicolored LED units or decreasing the light radiation flux of the at least one WLEDs to increase color gamut. On the other hand, adjusting the color gamut of the lighting structure is by increasing the light radiation flux of the at least one WLEDs or decreasing the light radiation flux of the at least one multicolored LED units to decrease power. Wherein the driving control system can be automatic controlled by a preset program or manually controlled by user, or by through a feedback system or a light sensing device to generate control parameter for automatic control, wherein presetting comprises input setting a first setting value of NTSC value and setting a first standard value of emitted light luminance; and user manual control comprises input setting a second setting value of NTSC value and setting a second standard value of emitted light luminance. And the lighting system further comprises a memory system for memorizing the control parameter; and a data processing system for automatically control the driving control system according to the control parameter.

In a method provided by the present invention provide, the method further provides a comparing step, the step is comparing environment luminance with system screen luminance, wherein light sensing device senses environment luminance and generates a reference value, the system screen luminance is a preset first standard value or a user input second standard value, the first standard value and the second standard value are fixed (for example, 250 nits). After comparing the reference value with the first standard value or the second standard value, a third setting value is generated and the following actions are performed according to the third value: if the environment luminance is higher than the screen luminance, increasing multicolored LED luminance to achieve high color gamut, at the same time the WLED luminance can be changed or remained; or increasing the WLED luminance to achieve relatively low power consumption, at the same time the multicolored LED luminance can be changed or remained. If the environment luminance is lower than the screen luminance, decreasing the WLED luminance to achieve high color gamut, at the same time the multicolored LED luminance can be changed or remained; or decreasing the multicolored LED luminance, at the same time the WLED luminance can be changed or remained.

In the present invention, it further comprises a feedback system, the feedback system is for detecting screen luminance to generate a third standard value, wherein the third standard value is for replacing the first standard value or the second standard value. With this, the present embodiment is able to automatically adjust screen luminance and compensate when screen luminance shift occurs.

The present invention can further be realized in a display system with adjustable color gamut, the display system comprises a liquid display panel and the above-described lighting system.

Furthermore, the present invention discloses a display system with adjustable color gamut can be practiced in devices with display system, for example, desk-top computers, lap-top computers, mobile phones, mobile televisions or televisions with liquid crystal displays etc.

Assuming light radiation fluxes of WLED and multicolored LED for providing light sources are R_{W} and R_{RGB} respectively and white light generated by both light radiation fluxes after passing through a color filter, the light radiation fluxes have coordinates (X_{W}, Y_{W}) and (X_{RGB}, Y_{RGB}) individually, which yields following formulae:

$$\begin{matrix}{X}_{( R , G , B )} = {X}_{W ( R , G , B )} \cdot \frac{{R}_{W}}{{R}_{W} + {R}_{RGB}} + {X}_{RGB ( R , G , B )} \cdot \frac{{R}_{RGB}}{{R}_{W} + {R}_{RGB}} & ( 1 ) \\ {Y}_{( R , G , B )} = {Y}_{W ( R , G , B )} \cdot \frac{{R}_{W}}{{R}_{W} + {R}_{RGB}} + {X}_{RGB ( R , G , B )} \cdot \frac{{R}_{RGB}}{{R}_{W} + {R}_{RGB}} & ( 2 )\end{matrix}$$

According to Formula (1) and Formula (2), the present invention can further control chrominance coordinates by controlling the light radiation flux R_{W} of the WLED for providing light sources and the light radiation flux R_{RGB} of the multicolored LED for providing light sources.

### BRIEF DESCRIPTION OF THE DRAWINGS

FIG. 1A and FIG. 1B describe block diagrams of a lighting system for generating backlight according to the present invention.

FIG. 2 describes a block diagram of a lighting system for generating backlight according to anther embodiment of the present invention.

FIG. 3 describes a block diagram of a lighting system for generating backlight according to anther embodiment of the present invention.

FIG. 4 describes a block diagram of a lighting system for generating backlight according to anther embodiment of the present invention.

### DETAILED DESCRIPTION OF THE INVENTION

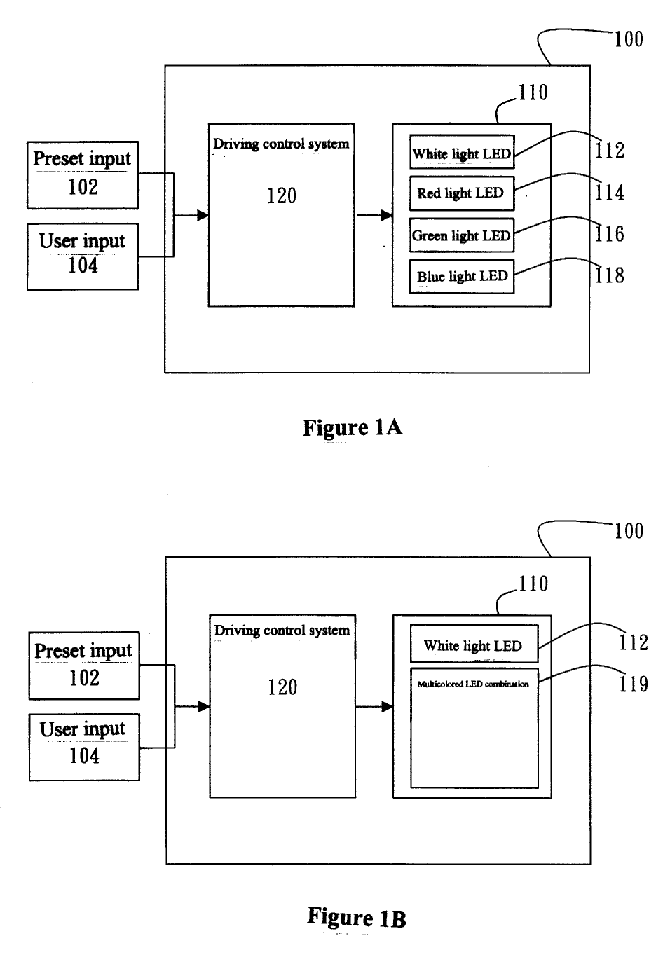

FIG. 1A and FIG. 1B describe a lighting system 100 for generating backlight, the lighting system comprises a lighting structure 110 with a light source and a driving control system 120, wherein the light source configuring at least one WLED 112 and at least one multicolored LED unit to obtain a layout of the lighting structure and in response to a plurality of driving signal to generate white light and the driving control system 120 for automatically providing a plurality of driving signals of the light source according to a preset first setting value of NTSC value or providing a plurality of driving signals of the light source according to a user input setting second setting value of NTSC value. In one embodiment, the at least one multicolored LED units comprise combinations of red light LED 114, green light LED 116 and blue light LED 118 or any multicolored LED combinations 119 that are able to mix up white light. In anther embodiment, the preset first setting value of NTSC value is set when producing the lighting system 100 and the user input setting second setting value of NTSC value can be set by users according to individual requirements.

According to one embodiment of the present invention, the first setting value comprises a NTSC value, which can be 70˜80% power-saving mode setting value, a NTSC value, which can be 80˜90% balance mode setting value and a NTSC value, which can be 90˜100% enriched mode setting value. On the other hand, the second setting value is used to manually setting the NTSC value to be between 70% and 100%.

In one embodiment, the driving control system 120 individually adjusts a light radiation flux of the at least one WLED and a light radiation flux of the at least one multicolored LED units by individually adjusting a electrical driving value provided to the at least one WLED and a light radiation flux of the at least one multicolored LED units, and through adjusting the light radiation fluxes to further adjust color gamut or luminance of the lighting structure 110. In anther embodiment, adjusting color gamut of the lighting structure 110 is by increasing the light radiation flux of the at least one multicolored LED units or decreasing the light radiation flux of the at least one WLEDs to increase color gamut. According to the embodiment, when requiring high color gamut, a method of increasing the light radiation flux of the at least one multicolored LED units to increase NTSC value is selected. On the other hand, when power-saving is required, a method of increasing the light radiation flux of the at least one WLED to save power is selected. Furthermore, users can manually control the two situations according to requirements.

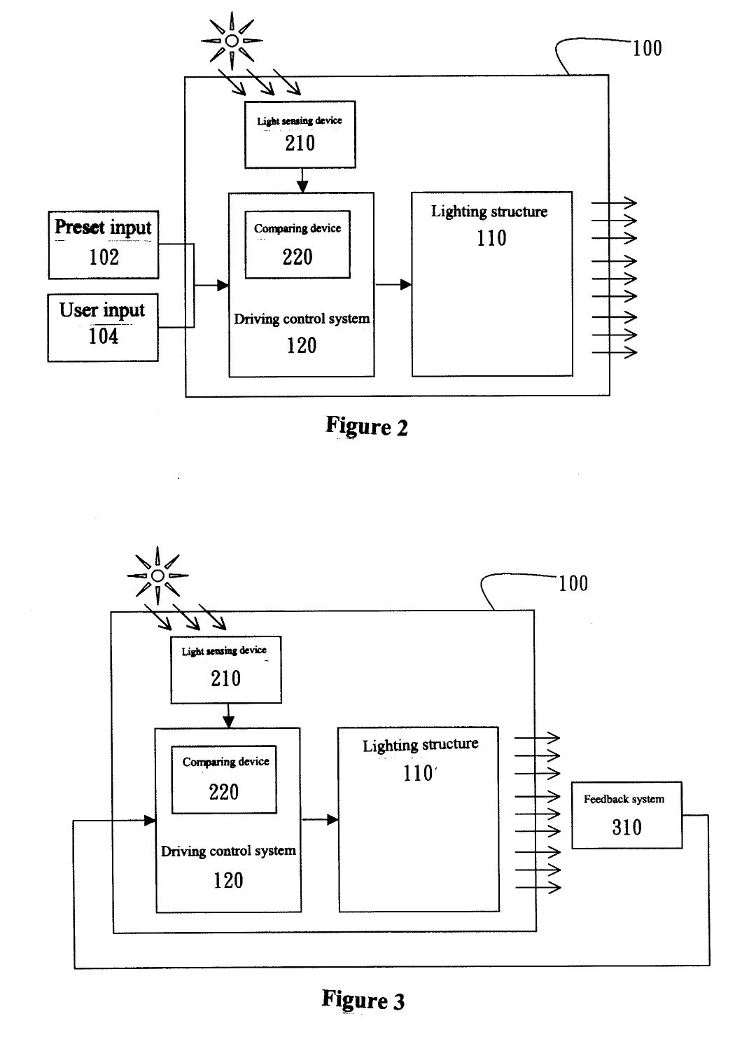

In another embodiment of the present invention, as shown in FIG. 2, the lighting system 100 further comprises a light sensing device 210 connected to outside of the driving control system, the light sensing device 210 is used for sensing environment luminance out of the lighting system 100 and generating a reference value, and the driving control system further comprises a comparing device 220, the comparing device is for comparing the reference value and a first standard value of preset 102 set screen luminance or a second standard value of user input 104 set screen luminance, wherein if the reference value is higher than the first standard value or the second standard value, the driving control system 120 increases color gamut (high luminance mode) by increasing the light radiation flux of the at least one multicolored LED unit and if the reference value is lower than the first standard value or the second standard value, the driving control system 120 increases color gamut (power-saving mode) by decreasing the light radiation flux of the at least one WLEDs. With methods disclosed in the embodiment, the present invention is able to automatically adjust color gamut according to user requirements of high luminance or power-saving. In another embodiment, further comprises a feedback system 310, the feedback system is for detecting screen luminance to generate a third standard value, as shown in FIG. 3, wherein the third standard value replaces the first standard value or the second standard value, with this, the present embodiment can automatically adjust screen luminance, and compensate when screen luminance shift occurs.

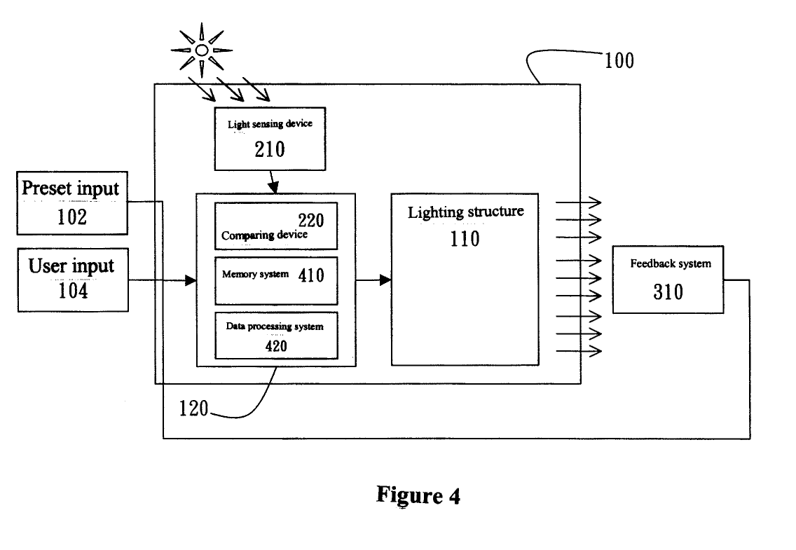

In one embodiment of the present invention, as shown in FIG. 4, the driving control system further comprises a memory system 410 and a data processing system 420, the memory system for memorizing one of the first setting value or one of the second setting value and the first standard value, the second standard value or the third standard value, and the data processing system controls the at least one multicolored LED units or the at least one WLEDs according to one of the first setting value or one of the second setting value and the first standard value, the second standard value or the third standard value.

Another embodiment of the present invention provides an operation method of a backlight system, the method comprise: providing at least one WLEDs and at least one multicolored LED units to generate a light source, providing a preset first setting value of NTSC value for a driving control system automatically providing a plurality of driving signals of the light source according to the first setting value or providing a user input second setting value of NTSC value for the driving control system providing a plurality of driving signals of the light source to adjust the light source according to the second setting value. Therefore providing desirable color gamut and white point, wherein the light source is white light and the at least one multicolored LED units comprise combinations of red light, green light and blue light LEDs or any multicolored LED combinations that are able to mix up white light.

According to the above embodiment, further comprises: one of steps of setting the first setting value to be a NTSC value, which is 70˜80% power-saving mode setting value, a NTSC value, which is 80˜90% balance mode setting value and a NTSC value, which is 90˜100% enriched mode setting value, and setting the second setting value to be a NTSC value, which is between 70% to 100%.

Furthermore, adjusting the light source is individually adjusting a light radiation flux of the at least one WLED and a light radiation flux of the at least one multicolored LED unit by individually adjusting electrical driving values provided to the at least one multicolored LED unit or the at least one WLED, and by adjusting the light radiation flux to further adjusting color gamut or luminance of the lighting structure.

In another embodiment, adjusting color gamut of the lighting structure is by increasing the light radiation flux of the at least one multicolored LED unit or decreasing the lighting structure of the at least one WLED to increase high color gamut.

According to the above embodiment, further comprises: detecting environment luminance out of the lighting system to generate a reference value and comparing the reference value with a first standard value of preset screen luminance or a second standard value of user input screen luminance, wherein after comparing, if the reference value is higher than the first standard value or the second standard value, the driving control system increases high color gamut (high luminance mode) by increasing the light radiation flux of the at least one multicolored LED unit and if the reference value is lower than the first standard value or the second standard value, the driving control system increases color gamut (power-saving mode) by decreasing the light radiation flux of the at least one WLED.

Furthermore, the above embodiment comprises detecting the light source generating a third standard value, wherein the third standard value is used to replace the first standard value or the second standard value. With this, the present embodiment can automatically adjust screen luminance, and compensate when screen luminance shift occurs and to achieve a purpose of automatic control.

According to the above-described embodiment, wherein comparing step is to compare the environment luminance with the system screen luminance, value of the system screen luminance is fixed (for example, 250 nit). If the environment luminance is higher than the screen luminance, increasing multicolored LED luminance to achieve high color gamut, at the same time the WLED luminance can be changed or remained; or increasing the WLED luminance to achieve low power, at the same time the multicolored LED luminance can be change or remained. If the environment luminance is lower than the screen luminance, decreasing the WLED luminance to achieve high color gamut, at the same time the multicolored LED luminance can be changed or remained; or decreasing the multicolored LED luminance, at the same time the WLED luminance can be changed or remained.

According to another embodiment of the present invention, a display system with adjustable color gamut comprises a liquid display panel and the above-described lighting system, wherein the lighting system can realize liquid crystal display system with low power and high color gamut through automatic control and manual control as disclosed in the specification of the present invention.

Furthermore, the present invention discloses a display system with adjustable color gamut can be practiced in devices with display system, for example, desk-top computers, lap-top computers, mobile phones, mobile televisions or televisions with liquid crystal displays etc.

1. A lighting system of generating backlight, comprising:
a lighting structure having a light source, wherein the light source configuring at least one white light emitting diode (WLED) and at least one multicolored light emitting diode (LED) unit to obtain a layout of the lighting structure, wherein the at least one multicolored LED units comprise combinations of red light, green light and blue light LEDs or any multicolored LED combinations that are able to mix up white light; and
a driving control system for automatically providing a plurality of driving signals of the light source according to a preset first setting value or providing a plurality of driving signals of the light source according to a second setting value of user input.

2. The lighting system according to claim 1, wherein the WLED is obtained by a blue light/green light exciteing phosphors.

3. The lighting system according to claim 1, wherein the WLED is obtained by a ultraviolet light exciteing phosphors.

4. The lighting system according to claim 1, wherein the multicolored LED unit is constructed by a plurality of single-colored light LEDs.

5. The lighting system according to claim 1, wherein the multicolored LED unit is obtained by multicolored light chip packaged in a package structure.

6. The lighting system according to claim 1, wherein the driving control system individually adjusting a light radiation flux of the at least one WLEDs and a light radiation flux of the at least one multicolored LED units by individually adjusting electrical driving values providing to the at least one multicolored LED units or the at least one WLEDs, and further adjusting a color gamut or color temperature of the lighting structure by adjusting the light radiation flux.

7. The lighting system according to claim 6, wherein adjusting the color gamut of the lighting structure is by increasing the light radiation flux of the at least one multicolored LED units or decreasing the light radiation flux of the at least one WLEDs to increase color gamut.

8. The lighting system according to claim 6, wherein adjusting the color gamut of the lighting structure is by increasing the light radiation flux of the at least one WLEDs or decreasing the light radiation flux of the at least one multicolored LED units to decrease power consumption.

9. An operating method of backlight system, the method comprising:
providing at least one of WLEDs and at least one multicolored LED units to generate a light source;
providing a preset first setting value for a driving control system to automatically provide a plurality of driving signals of the light source according to the first setting value or providing a second setting value input by user, for the driving control system to provide a plurality of driving signals of the light source according to the second setting value; and
adjusting driving signals of the light source so that the light source provides desired color gamut and white point, wherein the light source emits white light and the at least one multicolored LED units comprise combination of red light, green light and blue light LED or any or any multicolored LED combinations that are able to mix up white light.

10. The method according to claim 9, wherein the driving control system further provides a data processing system, the data processing system respectively calculates a plurality of driving signals of the WLED and the multicolored LED unit in the light source according to the first setting value or the second setting value.

11. The method according to claim 9, wherein by individually adjusting electrical driving value providing to the at least one multicolored LED units or the at least one WLEDs to individually adjust a light radiation flux of the at least one WLED and a light radiation flux of the at least one multicolored LED unit, and by adjusting the light radiation flux to further adjust color gamut or color temperature of the lighting structure.

12. The method according to claim 11, wherein adjusting color gamut of the lighting structure is by increasing the light radiation flux of the at least one multicolored LED units or decreasing the light radiation flux of the at least one WLEDs to increase color gamut.

13. The method according to claim 11, wherein adjusting the color gamut of the lighting structure is by increasing the light radiation flux of the at least one WLEDs or decreasing the light radiation flux of the at least one multicolored LED units to decrease power consumption.

14. A display system with adjustable color gamut, the display system comprising:
a liquid display panel; and
a lighting system generating backlight, comprising:
a lighting structure having a light source, wherein the light source configuring at least one WLED and at least one multicolored LED unit to obtain a layout of the lighting structure, wherein the at least one multicolored LED units comprise combinations of red light, green light and blue light LEDs or any multicolored LED combinations that are able to mix up white light; and
a driving control system for automatically providing a plurality of driving signals of the light source according to a preset first setting value or providing a plurality of driving signals of the light source according to a second setting value of user input.

15. The display system according to claim 14, wherein the driving control system further provides a data processing system, the data processing system respectively calculates a plurality of driving signals of the WLED and the multicolored LED unit in the light source according to the first setting value or the second setting value.

16. The display system according to claim 14, wherein by individually adjusting electrical driving value providing to the at least one multicolored LED units or the at least one WLEDs to individually adjust a light radiation flux of the at least one WLED and a light radiation flux of the at least one multicolored LED unit, and by adjusting the light radiation flux to further adjust color gamut or color temperature of the lighting structure.

17. The display system according to claim 16, wherein adjusting color gamut of the lighting structure is by increasing the light radiation flux of the at least one multicolored LED units or decreasing the light radiation flux of the at least one WLEDs to increase color gamut.

18. The display system according to claim 16, wherein adjusting the color gamut of the lighting structure is by increasing the light radiation flux of the at least one WLEDs or decreasing the light radiation flux of the at least one multicolored LED units to decrease power consumption.

19. A desktop computer comprising the display system with adjustable color gamut according to claim 14.

20. A laptop computer comprising the display system with adjustable color gamut according to any one of claims 14 to 18.

21. A mobile device comprising the display system with adjustable color gamut according to claim 14, wherein the mobile device comprises mobile phone or mobile television.

22. A display system with adjustable color gamut according to environment luminance, the display system comprising:
a liquid display panel; and
a lighting system generating backlight, comprising:
a lighting structure having a light source, wherein the light source configuring at least one WLED and at least one multicolored LED unit to obtain a layout of the lighting structure, wherein the at least one multicolored LED units comprise combinations of red light, green light and blue light LEDs or any multicolored LED combinations that are able to mix up white light; and
a driving control system for automatically providing a plurality of driving signals of the light source according to a preset first setting value or providing a plurality of driving signals of the light source according to a second setting value of user input;
a light sensing device, the feedback device for sensing ambient brightness, and adjusting driving signals of the WLED and multicolored LED unit in the light source according to sensing result.

23. The display system according to claim 22, the light sensing device connecting to the driving control system for sensing ambient brightness outside the lighting system and generate a reference value.

24. The display system according to claim 23 further comprising a comparing device for comparing the reference value and a first standard value of preset system luminance or a second standard value of user-set system luminance, and with comparing result generating a third setting value.

25. The display system according to claim 24 further comprising a driving control system for automatically providing a plurality of driving signals of the light source according to the third setting value.

26. The display system according to claim 25, the driving control system further comprising a data processing device, the data processing device calculates a plurality of driving signals of the WLED and the multicolored LED unit in the light source according to the third setting value.

27. The display system according to claim 24 further comprising a feedback system for detecting screen luminance to generate a third standard value, wherein the third standard value is for replacing the first standard value or the second standard value.

28. The display system according to claim 24, if the reference value is higher than the first standard value or the second standard value, the driving control system increases color gamut by increasing the light radiation flux of the multicolored LED unit.

29. The display system according to claim 24, if the reference value is lower than the first standard value or the second standard value, the driving control system increases color gamut by decreasing the light radiation flux of the WLED.

30. The display system according to claim 27, if the reference value is higher than the third standard value, the driving control system increases color gamut by increasing the light radiation flux of the multicolored LED unit.

31. The display system according to claim 27, if the reference value is lower than the third standard value, the driving control system increases color gamut by decreasing the light radiation flux of the WLED.

32. A desktop computer comprising the display system with adjustable color gamut according to claim 22.

33. A laptop computer comprising the display system with adjustable color gamut according to claim 22.

34. A mobile device comprising the display system with adjustable color gamut according to claim 22, wherein the mobile device comprises mobile phone or mobile television.

35. A display system comprising the display system with adjustable color gamut according to claim 22, wherein the display system comprises television.
